(19) United States
(12) Patent Application Publication
(10) Pub. No.: US 2007/0223098 A1
(43) Pub. Date: Sep. 27, 2007

(54) Light filtering and strong light-preventing device for the front seat of an automobile

(75) Inventor: Chin-Fu Chuang, Tainan City (TW)

Correspondence Address: Chin-Fu Chuang, P.O. Box 6-9 (717), Tainan, TW

(73) Assignee: CROWNRAY OPTIC CO., LTD

(21) Appl. No.: 11/351,960

(22) Filed: Feb. 13, 2006

(51) Int. Cl. G02B 27/00

(52) U.S. Cl. 359/601

(57) ABSTRACT

A light filtering and strong light-preventing device for the front seat of an automobile includes a base body and a strong light-preventing sheet. The base body to be positioned on the windshield or on the visor of an automobile is provided with positioning members, a collapsing mechanism and a control switch. The strong light-preventing sheet is collapsed in the interior of the basic body. When the sunlight is strong, only pull out the strong light-preventing sheet to a suitable length for filtering and blocking the sunlight. To collapse the strong light-preventing sheet, simply press the control switch to start the collapsing mechanism to collapse the strong light-preventing sheet in the interior of the base body, convenient in use and taking a small space.

### BACKGROUND OF THE INVENTION

1. Field of the Invention

This invention relates to a light filtering and strong light-preventing device for the front seat of an automobile, particularly to one provided with a strong light-preventing sheet able to be pulled out of a base body to adjust its light filtering area for blocking off and filtering strong light so as to insure driving safety.

2. Description of the Prior Art

Generally, one of the troubles a driver encounters is that the sun projects light upon the eyes directly, so the driver cannot open his eyes and impossible to drive with safety. To solve such a problem, a driver usually has to wear dark glasses for blocking off the strong sunlight. However, when a driver forgets to bring dark glasses with him, or if a driver is nearsighted or farsighted and already has glasses on but has to additionally wear dark glasses, it will surely cause much trouble to the driver. Although each automobile has a visor provided over the front seat for blocking off the sunlight, yet the visor that is opaque may also obstruct a driver's eyesight. In another case, if the driver is short-statured, and when the sun rises or is to set and horizontally projects light to the interior of an automobile, the visor above the front seat will become useless and the driver has to wear dark glasses for blocking off the sunlight.

### SUMMARY OF THE INVENTION

A first objective of the invention is to offer a light filtering and strong light-preventing device for the front seat of an automobile, which is provided with a strong light-preventing sheet able to be collapsed in a base body and pulled out to a most suitable light filtering area for blocking and filtering strong light so as to insure driving safety.

A second objective of the invention is to offer a light filtering and strong light-preventing device for the front seat of an automobile, which can effectively prevent ultraviolet rays from injuring a driver's eyes.

A third objective of the invention is to offer a light filtering and strong light-preventing device for the front seat of an automobile, which can be conveniently collapsed and pulled out for use.

### BRIEF DESCRIPTION OF DRAWINGS

This invention will be better understood by referring to the accompanying drawings, wherein:

FIG. 1 is a perspective view of a first preferred embodiment of a light filtering and strong light-preventing device in the present invention;

FIG. 2 is a cross-sectional view of the first preferred embodiment of the light filtering and strong light-preventing device in a using condition in the present invention;

FIG. 3 is a perspective view of the first preferred embodiment of the light filtering and strong light-preventing device in a using condition in the present invention;

FIG. 4 is a side-sectional view of the first preferred embodiment of the light filtering and strong light-preventing device assembled on the windshield of an automobile in the present invention;

FIG. 5 is a perspective view of a second preferred embodiment of a light filtering and strong light-preventing device in the present invention;

FIG. 6 is a perspective view of the second preferred embodiment of a light filtering and strong light-preventing device in a using condition in the present invention;

FIG. 7 is a side-sectional view of the second preferred embodiment of a light filtering and strong light-preventing device used for preventing strong light in the daytime in the present invention;

FIG. 8 is a side-sectional view of the second preferred embodiment of a light filtering and strong light-preventing device used at night for preventing the light coming from opposite cars in the present invention; and

FIG. 9 is a cross-sectional view of the light filtering and strong light-preventing device assembled on a visor in the present invention.

### DETAILED DESCRIPTION OF THE PREFERRED EMBODIMENT

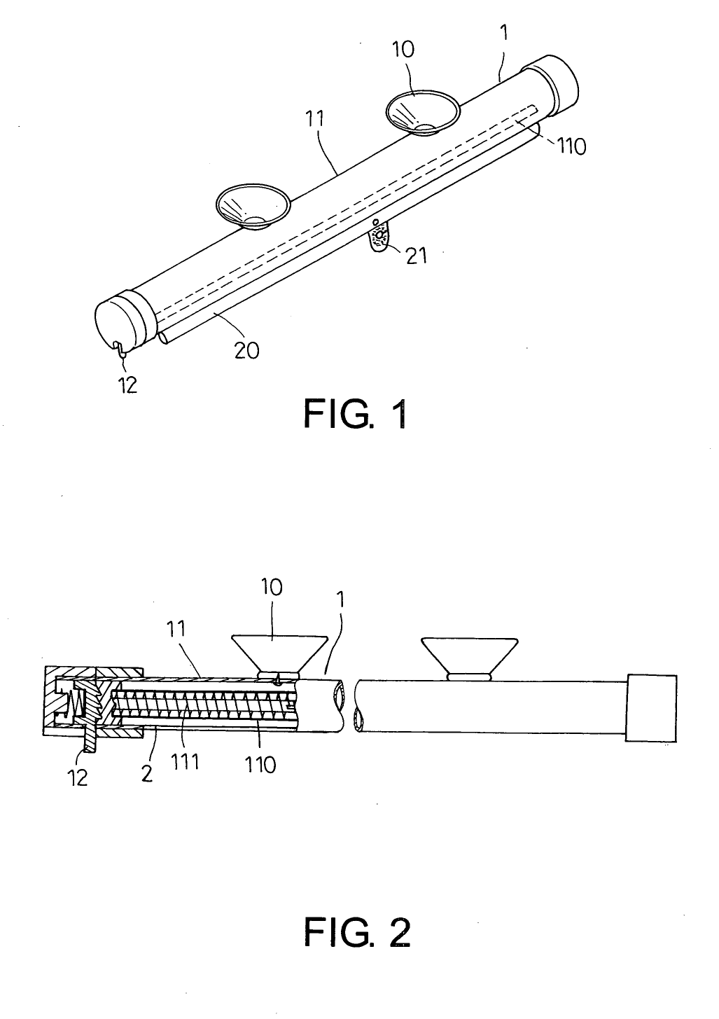

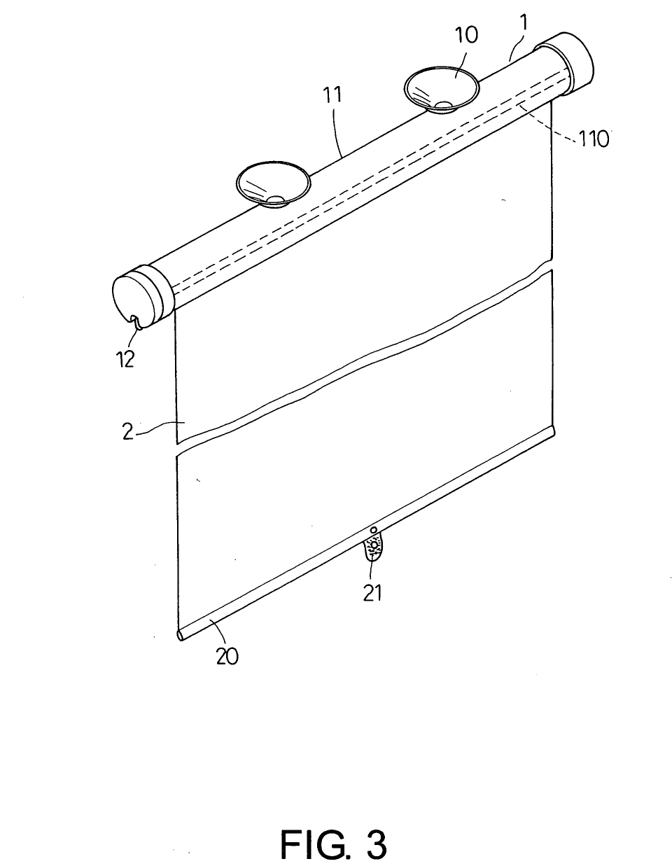

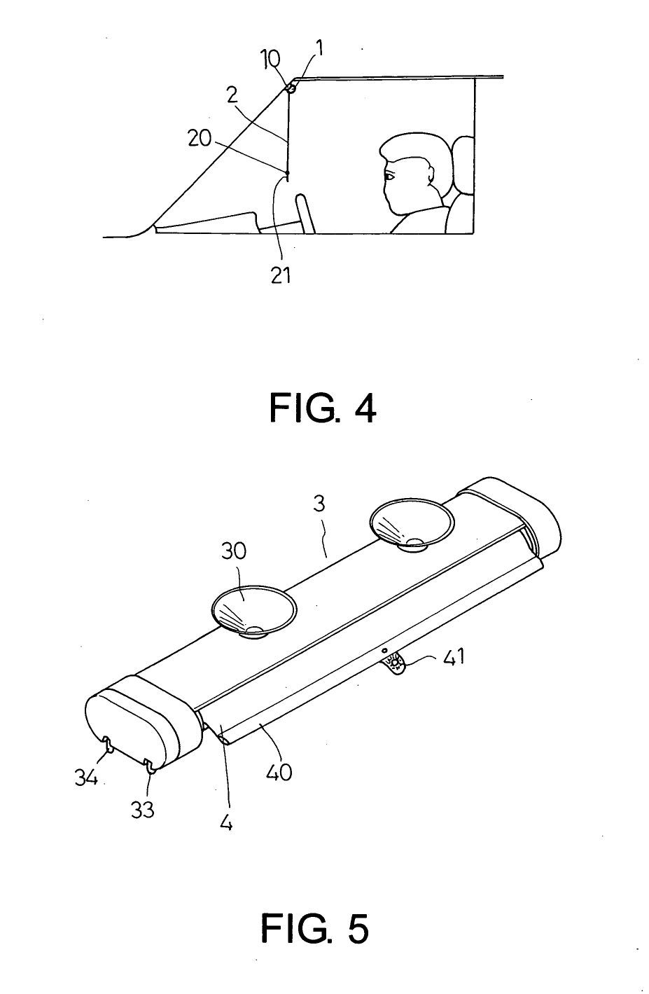

A first preferred embodiment of a light filtering and strong light-preventing device for the front seat of an automobile in the present invention, as shown in FIGS. 1-4, includes a base body 1 and a strong light-preventing soft sheet 2 combined together.

The base body 1 is provided thereon with positioning members 10 like suction disks or clips and has its interior installed with a collapsing mechanism 11 composed of a rod body 110 and an elastic member 111. The collapsing mechanism 11 has one side provided with a control switch 12 to be pressed for actuating the rod body 110 to rotate or stop its rotating.

The strong light-preventing soft sheet 2 is made of soft and transparent plastic able to filter and block light. The strong light-preventing sheet 2 has one end secured on the rod body 110 of the collapsing mechanism 11 to be rolled on the rod body 110 and the other end provided with a stop member 20 and a pull member 21.

In using, the positioning members 10 of the base body 1 is firmly positioned on the windshield of an automobile and then hold the pull member 21 and pull out the strong light-preventing sheet 2 to a proper location for filtering light. To collapse the strong light-preventing sheet 2, simply press the control switch 12 to disengage rod body 110 to let it rotated by the torsion force of the elastic member 111 to roll up the strong light-preventing sheet 2 thereon until it is stopped by the stop member 20, convenient in operating.

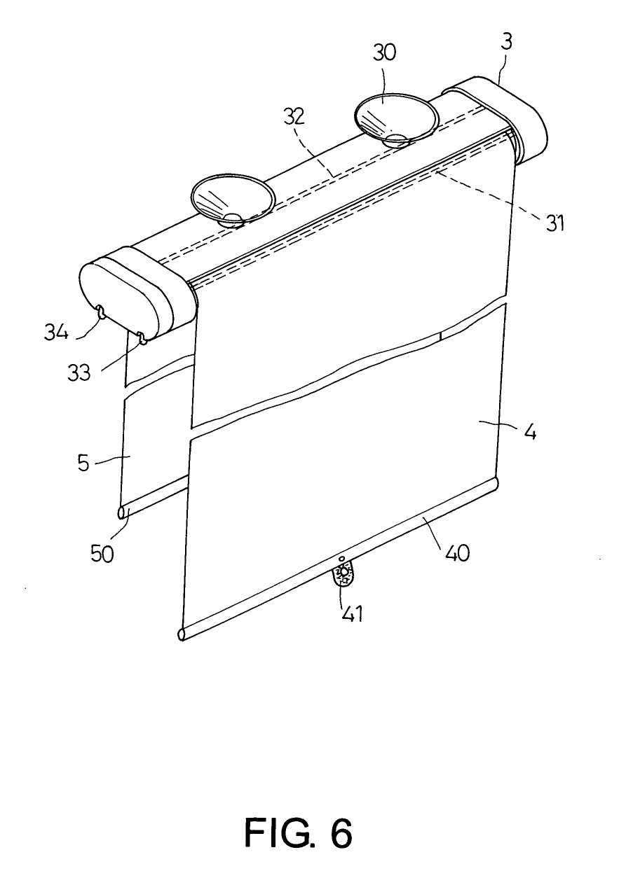

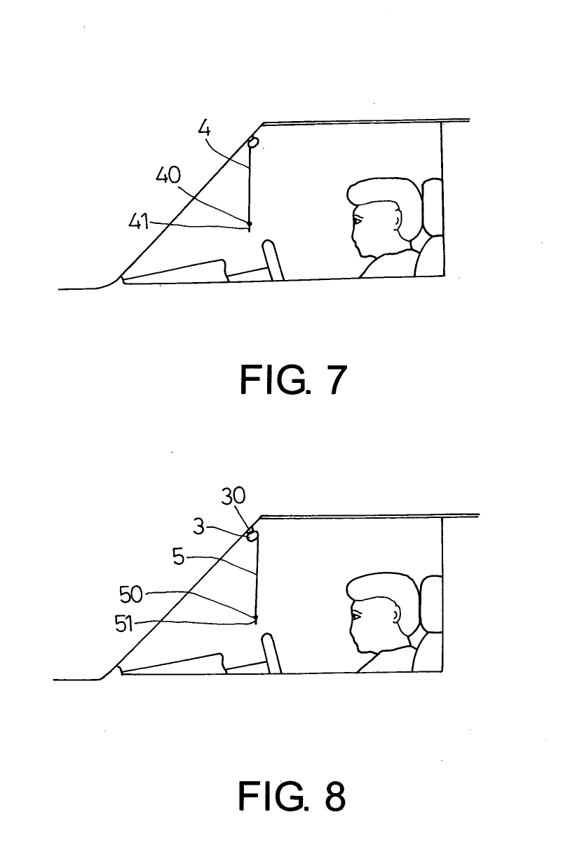

A second preferred embodiment of a light filtering and strong light-preventing device for the front seat of an automobile in the present invention, as shown in FIGS. 5-8, includes a base body 3, a daytime strong light-preventing soft sheet 4 and a nighttime strong light-preventing soft sheet 5.

The base body 3 is provided with positioning members 30 and installed in the interior with two collapsing mechanisms 31, 32, which respectively have one side assembled with a control member 33, 34 to be pressed for controlling the collapsing mechanism 31, 32 to operate.

The daytime strong light-preventing sheet 4 collapsed on the collapsing mechanism 31 of the base body 3 is made of soft, dark brown and light filtering material. The daytime strong light-preventing sheet 4 has one end fixed on the collapsing mechanism 31 and the other end provided with a stop member 40 and a pull member 41.

The nighttime strong light-preventing sheet 5 assembled on the collapsing mechanism 32 of the base body 3 is made of a soft, yellow and thin filtering material. The nighttime strong light-preventing sheet 5 has one end secured on the collapsing mechanism 32 and the other end provided with a stop member 50 and a pull member 51.

In using, the positioning members 30 of the base body 3 are firmly positioned on the windshield of an automobile. When driving out, a driver can optionally use a suitable strong light preventing sheet according to the weather. When the sunlight is strong, simply pull down the daytime strong light-preventing sheet 4 for blocking off the strong sunlight. To collapse the daytime strong light-preventing sheet 4, only press the control member 33 to collapse the daytime strong light-preventing sheet 4 in the collapsing mechanism 31 of the base body 3. When driving at night, just pull out the nighttime strong light-preventing sheet 5 for use. The nighttime strong light-preventing sheet 5 does not affect a driver's eyesight and can filter the light coming from the opposite cars, thus enabling a driver to drive with concentration to insure driving safety.

As can be understood from the above description, this invention has the following advantages.

1. The light filtering and strong light-preventing device of this invention can be optionally used at daytime or at nighttime for blocking off strong light so a driver does not need to wear sunglasses.

2. The light filtering and strong light-preventing device of this invention can be easily positioned on the windshield or on the visor of an automobile, very convenient to fix its position.

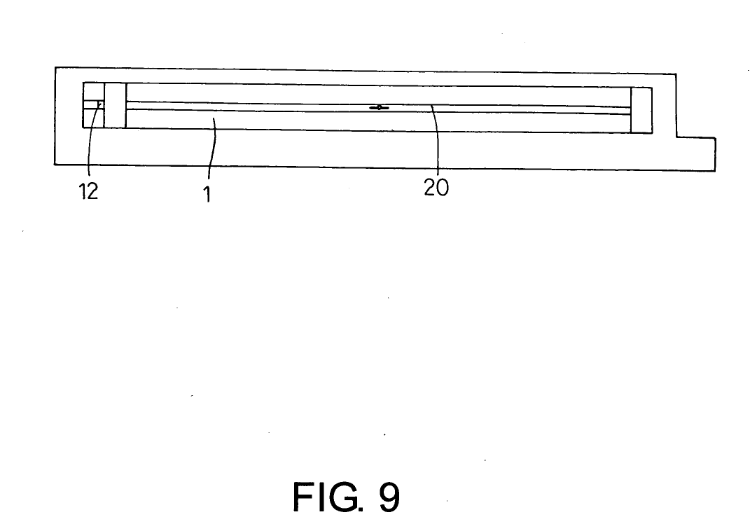

3. The base body 1, 3 of the light filtering and strong light-preventing device of this invention can be directly fitted on the front visor for use, as shown in FIG. 9.

4. The strong light-preventing sheet of the light filtering and strong light-preventing device can be collapsed conveniently, taking a small space.

5. The strong light preventing-sheet of the light filtering and strong light-preventing device can be used at other places for blocking the sunlight.

6. The strong light-preventing sheet of the light filtering and strong light-preventing device is made of soft plastic so it is not easy to be broken or damaged.

7. The light filtering and strong light-preventing device of this invention can block off ultraviolet trays to protect a driver's eyes.

While the preferred embodiments of the invention have been described above, it will be recognized and understood that various modifications may be made therein and the appended claims are intended to cover all such modifications that may fall within the spirit and scope of the invention.

I claim:

1. A light filtering and strong light-preventing device for the front seat of an automobile, said device comprising;
a base body installed with a collapsing mechanism in its interior, said base body provided thereon with positioning members;
a strong light-preventing sheet having one end fixed in said collapsing mechanism of said base body, said strong light-preventing sheet made of soft and transparent plastic able to block and filter strong light; and
said light filtering and strong light-preventing device able to be positioned on the windshield of an automobile, said strong light-preventing sheet able to be pulled out for blocking and filtering strong light.

2. A light filtering and strong light-preventing device for the front seat of an automobile, said device comprising;
a base body provided with positioning members and two collapsing mechanisms;
said two collapsing mechanisms respectively having a strong light-preventing sheet fixed in its interior, one of said strong light-preventing sheets used in the daytime, the other of said strong light-preventing sheets used for in the nighttime; and
said two strong light-preventing sheets able to be optionally employed for blocking and filtering strong light.

3. The light filtering and strong light-preventing device for the front seat of an automobile as claimed in claim 1 or 2, wherein said collapsing mechanism is composed of a rod body, an elastic member and a control switch, and said strong light-preventing sheet can be adjusted in its light filtering area according to practical needs and can also be collapsed in said collapsing mechanism.

4. The light filtering and strong light-preventing device for the front seat of an automobile as claimed in claim 1 or 2, wherein said base body can be fitted on a visor of an automobile and said strong light-preventing sheet can be pulled out for blocking and filtering strong light.

5. The light filtering and strong light-preventing device for the front seat of an automobile as claimed in claim 2, wherein both said daytime strong light-preventing sheet and said nighttime strong light-preventing sheet can simultaneously be pulled out for blocking off the sunlight and lowering the internal temperature of an automobile.

6. The light filtering and strong-preventing device for the front seat of an automobile as claimed in claim 1 or 2, wherein said light filtering and strong light-preventing device has functions of blocking and filtering strong light, so a driver having myopic spectacles on does not need to wear sunglasses any more.

7. A light filtering and strong light-preventing device for the front seat of an automobile comprises a base body and a strong light-preventing sheet, said strong light-preventing sheet made of soft, transparent and light filtering material able to prevent strong light as well as ultraviolet rays.
